(19) United States
(12) Patent Application Publication
(10) Pub. No.: US 2009/0227352 A1
(43) Pub. Date: Sep. 10, 2009

(54) Gaming Machine with Mechanical Reel Rotatable Through Player's Operation and Confirmation Method of Symbol

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/394,928

(22) Filed: Feb. 27, 2009

Related U.S. Application Data
(60) Provisional application No. 61/035,171, filed on Mar. 10, 2008.

(51) Int. Cl. A63F 9/24; A63F 13/00

(52) U.S. Cl. 463/20; 463/31

(57) ABSTRACT

A gaming machine includes: a game requiring a player's bet, a reel used in the game and mechanically driven to rotate, a plurality of symbols on the reel, an input device which receives an input by the player, and a controller which is programmed to carry out the steps of: (a1) receiving an input inputted into the input device; and (a2) when the input is a rotation command related to the reel, rotating the reel while the rotation command is being inputted.

### CROSS REFERENCE TO RELATED APPLICATION

The present application claims priority from provisional application No. 61/035,171, which was filed on Mar. 10, 2008, the entire disclosure of which is herein incorporated by reference.

### BACKGROUND OF THE INVENTION

1. Field of the Invention

The present invention relates to a gaming machine capable of awarding a payout according to a combination of a plurality of symbols, and a confirmation method of a symbol.

2. Description of Related Art

A known gaming machine, as disclosed in U.S. Pat. No. 5,580,055, has a cabinet, a plurality of cylindrical reels arranged in parallel in the cabinet, a plurality of symbols arranged on an outer circumferential surface of each of the reels, a drive mechanism which rotatably supports each of the reels, and a reel window through which a part of the outer circumferential surface of the reels is visible from outside the cabinet. In this gaming machine, by rotating each of the reels, the symbols on each reel are variably displayed inside the reel window. When each of the reels stop, and the combination of the symbols shown in the reel windows form a predetermined combination, a payout according to the combination of the symbols is awarded. Thus, in a known gaming machine, arrangements or combinations of symbols are closely related to a profit of a player.

The objects of the present invention are to provide a gaming machine which enables a player to easily recognize an arrangement of a symbol on a reel, and a confirmation method of a symbol.

### SUMMARY OF THE INVENTION

The present invention deals with a gaming machine including: a game requiring a player's bet; a reel used in the game and mechanically driven to rotate; a plurality of symbols on the reel; an input device which receives an input by the player; and a controller which is programmed to carry out the steps of: (a1) receiving input inputted through the input device; and (a2) when the input is a rotation command related to the reel, rotating the reel while the rotation command is being inputted.

For example, the reel rotates while the player is inputting a rotation command through the input device. In short, the reel rotates in response to an operation by the player. Hence, the player is able to successively confirm the symbols actually arranged on the reel by the player him/herself carrying out an operation to rotate the reel. Thus, the gaming machine enables the player to easily recognize a symbol arrangement.

The present invention deals with a gaming machine including: a game requiring a player's bet; a reel, for use in the game, which is mechanically driven to rotate and whose rotation direction is switchable ; a plurality of symbols on the reel; a display capable of generating a video image; an input device disposed so that at least a part of the display area of the display is visible through the input device, and for receiving an input through a press operation by the player; and a controller which is programmed to carry out the steps of: (b1) displaying a video image of a direction symbol indicating a rotation direction of the reel; (b2) specifying an input position in the input device; (b3) when the input position corresponds to a display position of the direction symbol, determining that the input is a rotation command related to the reel; and (b4) rotating the reel in a rotation direction indicated by the direction symbol while the rotation command is being inputted.

The above structure enables a player to input a rotation command related to a reel associated with a direction symbol by pressing a specific area, of the input device, corresponding to a display position of the direction symbol, while a video image of the direction symbol is visible on the display. In short, the reel is rotatable in response to an operation by the player, and is capable of switching its rotation directions. Moreover, the rotation directions of the reel are shown as images. Hence, the player is able to successively confirm the symbols actually arranged on the reel by the player him/herself carrying out an operation to rotate the reel. Thus, the gaming machine enables the player to easily recognize a symbol arrangement. Moreover, with the gaming machine, the player who operates the reel is able to easily determine a rotation direction of the reel.

The present invention deals with a gaming machine including: a game requiring a player's bet; a plurality of reels used in the game and mechanically driven to rotate; a plurality of symbols on each of the reels; a display capable of generating a video image; an input device disposed so that at least a part of the display area of the display is visible through the input device, for receiving an input through a press operation by the player; and a controller which is programmed to carry out the steps of: (c1) associating each of the reels with a video image of a direction symbol indicating a rotation direction of the reel, and display the video images; (c2) specifying an input position in the input device; (c3) when the input position corresponds to a display position of the direction symbol, determining that a rotation command related to a reel is inputted; and (c4) rotating the reel associated with the direction symbol in a rotation direction indicated by the direction symbol while the rotation command is being inputted.

The above structure enables a player to input a rotation command related to a reel associated with a direction symbol by pressing a specific area, of the input device, corresponding to a display position of the direction symbol, while a video image of the direction symbol is visible on the display. In short, a reel is selected through the player's operation, and the selected reel is rotatable. Hence, the player is able to successively confirm the symbols actually arranged on the reels by the player him/herself carrying out an operation to rotate the reel. Thus, the gaming machine enables the player to easily recognize the symbol arrangement. Moreover, with the gaming machine, the player who operates the reels is able to easily determine a rotation direction of each of the reels.

The present invention deals with a gaming machine including: a game requiring a player's bet; a plurality of reels, for use in the game, which are mechanically driven to rotate and whose rotation directions are switchable ; a plurality of symbols on each of the reels; a display capable of generating a video image; an input device disposed so that at least a part of a display area of the display is visible through the input device, for receiving an input through a press operation by the player; and a controller which is programmed to carry out the steps of: (d1) associating each of the reels with a video image of a direction symbol indicating a rotation direction of the reel, and display the video images; (d2) specifying an input position in the input device; (d3) when the input position corresponds to a display position of the direction symbol, determining that a rotation command related to a reel is inputted; and (d4) rotating the reel associated with the direction symbol in a rotation direction indicated by the direction symbol while the rotation command is being inputted.

The above structure enables a player to input a rotation command related to a reel associated with a direction symbol simply by pressing a specific area, of the input device, corresponding to a display position of the direction symbol, while a video image of the direction symbol is visible on the display. In short, the player is able to select a reel through his/her operation. Moreover, the selected reel is rotatable in one direction or the other. A rotation direction of a reel is shown as an image. Thus, the player is able to successively confirm the symbols actually arranged on the reel by the player him/herself carrying out an operation to rotate the reel. In addition, with the gaming machine, the player who operates the reels is able to easily select a reel and determine a rotation direction of the reels.

The present invention deals with a confirmation method of a plurality of symbols on a reel which is mechanically driven to rotate and used in a game requiring a player's bet. The reel rotates while a rotation command is being inputted by the player.

According to the above structure, the reel rotates while the player is inputting a rotation command. In short, the reel rotates in response to an operation by the player. Thus, the player is able to successively confirm the symbols actually arranged on the reel by the player him/herself carrying out an operation to rotate the reel. Thus, the confirmation method enables the player to easily recognize a symbol arrangement.

### BRIEF DESCRIPTION OF THE DRAWINGS

FIG. 1 is an explanatory drawing showing a playing method of a gaming machine.

FIG. 2 is a block diagram of a gaming machine.

FIG. 3 is a perspective view showing an exterior of a gaming machine.

FIG. 4 is a block diagram showing a control circuit of a gaming machine.

FIG. 5 is a block diagram of a graphic board.

FIG. 6 is an explanatory drawing of a data table showing symbols and code numbers of each of the symbols.

FIG. 7 is an explanatory drawing of a data table of a payout control table.

FIG. 8 is an explanatory drawing of a data table of a free game quantity table.

FIG. 9 is an explanatory drawing of a display screen in a help mode.

FIG. 10 is an explanatory drawing of a display screen in a reel confirmation mode.

FIG. 11 is an explanatory drawing of a mini game screen.

FIG. 12 is a flow chart of a boot process.

FIG. 13A is a flow chart showing part of a basic game process.

FIG. 13B is a flow chart showing another part of a basic game process.

FIG. 14 is a flow chart showing a free game process.

FIG. 15 is flow chart showing a mini game process.

FIG. 16 is a flow chart of a help process.

FIG. 17 is a flow chart of a reel confirmation process

### DESCRIPTION OF THE PREFERRED EMBODIMENTS

The following describes a preferred embodiment of a gaming machine according to the present invention.

(Overview of the Gaming Machine)

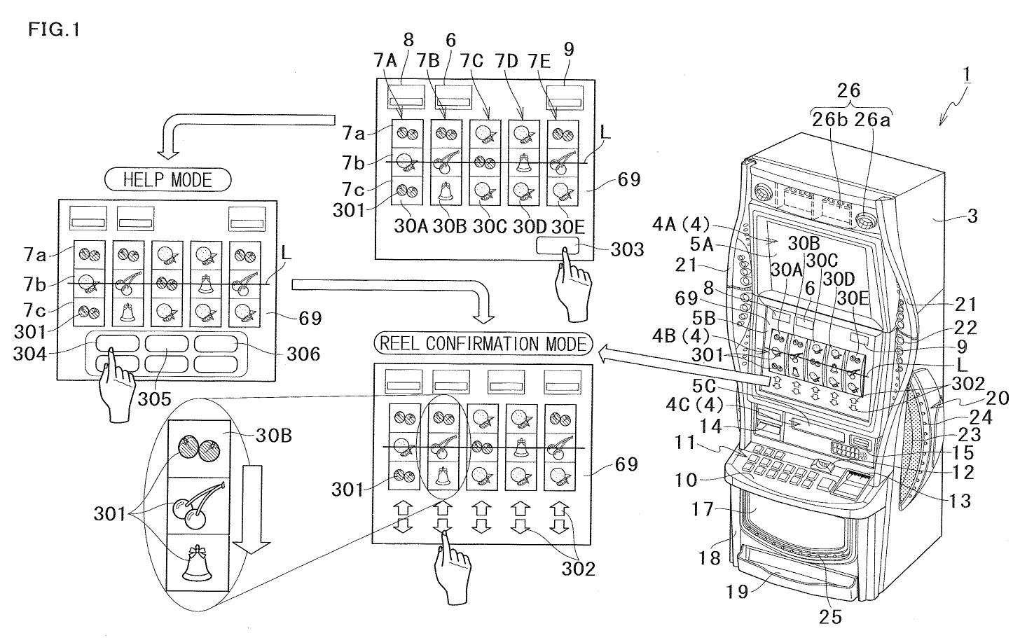

As shown in FIG. 1, a gaming machine (slot machine 1) has one or more mechanical reels 30A, 30B, 30C, 30D, and 30E which rotate in response to a player's operation.

Specifically, the gaming machine includes: a game requiring a player's bet; reels 30A to 30E used in the game and mechanically driven to rotate, symbols 301 on the reels 30A to 30E, an input device (touch panel 69 or the like) which receives an input by the player, and a controller that carries out the following steps of (a1) and (a2).

Specifically, the controller carries out the steps of: (a1) receiving an input inputted through the input device; and (a2) when the input is a rotation command related to one or more of the reels 30A to 30E, rotating the one or more of the reels 30A to 30E while the command is being inputted.

The gaming machine may be a machine such as a slot machine 1 or the like for one player, or multiple players. For instance, a gaming machine for multiple players may include several slot machines 1 which are connected to one another and are capable of carrying out data communication with one another.

In addition to a function of running a game with mechanical reels 30A to 30E, the gaming machine may have a function of running one or more games through another mechanical operation, an electrical operation, or through a combination of mechanical and electrical operations. An example of an electrically operated gaming machine is a slot machine 1 which displays an image of reels 30A to 30E on a display of liquid crystal or the like, and virtually rotates or moves reels 30A to 30E. Note that a slot machine 1 is shown as an example of a gaming machine in the present embodiment; however, the gaming machine is not limited to this.

An input device is not specifically limited as long as the input device enables a player's operation to input information therethrough. Specifically, an input device may be a touch panel 69 disposed on an upper surface of a central liquid crystal panel 5B, or an operation button 11 which enables an input by connection/disconnection of mechanical contact points. Moreover, an input device may be a device which enables input of information through a data communication using wireless signals such as sound, light, radio wave, or the like.

A gaming machine with such structures realizes a confirmation method of a below mentioned symbol 301. In other words, a confirmation method of a symbol 301 is a method used in a game requiring a player's bet for confirming a plurality of symbols 301 on reels 30A to 30E which are mechanically driven to rotate. The reels 30A to 30E rotate while the rotation command is being inputted by the player.

Thus, the reels 30A to 30E rotate while the player is inputting a rotation command through the input device. In other words, the reels 30A to 30E rotate in response to an operation by the player. Thus, the player is able to successively confirm the symbols 301 actually arranged on the reels by the player him/herself carrying out an operation to rotate the reels 30A to 30E. As a result, the gaming machine enables the player to easily recognize a symbol arrangement.

Moreover, the gaming machine rotates one or more mechanical reels 30A, 30B, 30C, 30D, and 30E, and enables switching of their rotation directions in response to a player's operation of a touch panel 69.

Specifically, the gaming machine includes a game requiring a player's bet; reels 30A to 30E, for use in the game, which are mechanically driven to rotate and whose rotation directions are switchable; symbols 301 on reels 30A to 30E; a display (central liquid crystal panel 5B) capable of generating a video image; a touch panel 69 disposed so that at least a part of display area of the display is visible through the touch panel 69, for receiving an input by the player's press operation; and a controller which is programmed to carry out the following steps of (b1) to (b4).

Specifically, the controller carries out the steps of: (b1) displaying video images of direction symbols 302 respectively indicating rotation directions of the reels 30A to 30E; (b2) specifying an input position in the touch panel 69; (b3) when the input position corresponds to a display position of the direction symbols 302, determining that a rotation command related to one or more of the reels 30A to 30E is inputted; and (b4) rotating the one or more of the reels 30A to 30E in a rotation direction indicated by the direction symbols 302.

Examples of the display are a liquid crystal display device, a CRT (cathode-ray tube) device, a plasma display device, or the like. Moreover, either a single display or plural displays may be provided to the slot machine 1. As for a gaming machine for multiple players, a display may be provided to each slot machine 1, or a large screen display shared by all the slot machines 1 may be provided in addition to the slot machines 1.

The above structure enables a player to input a rotation command related to a at least one of the reels 30A to 30E each associated with a direction symbol 302 simply by pressing a specific area, of the touch panel 69, corresponding to a display position of the direction symbol 302, while a video image of the direction symbol is visible on the display. In short, the reels 30A to 30E are rotatable in response to an operation by the player, and capable of switching their rotation directions. In addition, rotation directions of the reels 30A to 30E are shown as images. Thus, the player is able to successively confirm the symbols 301 actually arranged on the reels 30A to 30E when the reels 30A to 30E rotate in response to an operation by the player. As a result, the gaming machine enables the player to easily recognize a symbol arrangement. Moreover, the gaming machine enables the player who operates the reels 30A to 30E to easily determine a rotation direction of the reels 30A to 30E.

Moreover, the gaming machine is structured so that mechanical reels 30A to 30E are selectively rotated through a player's operation of the touch panel 69.

Specifically, the gaming machine includes; a game requiring a player's bet; reels 30A to 30E, for use in the game, which are mechanically driven to rotate; symbols 301 on each of the reels 30A to 30E; a display capable of generating a video image; a touch panel 69 disposed so that at least a part of a display area of the display is visible through the touch panel 69, for receiving an input through a press operation by the player; and a controller which is programmed to carry out the following steps of (c1) to (c4).

Specifically, the controller is programmed to carry out the steps of: (c1) associating each of the reels 30A to 30E with a video image of a direction symbol 302 indicating a rotation direction of the reel, and displaying the video images; (c2) specifying an input position in the touch panel 69; (c3) when the input position corresponds to a display position of the direction symbols 302, determining that a rotation command related to one or more of the reels 30A to 30E is inputted; and (c4) rotating the one or more of the reels 30A to 30E associated with the direction symbol 302 in a rotation direction indicated by the direction symbol 302 while the rotation command is being inputted.

Therefore, the gaming machine enables the player to select one or more of the specific reels 30A to 30E through his/her operation.

The gaming machine is structured so that, through a player's operation of the touch panel 69, mechanical reels 30A, 30B, 30C, 30D, and 30E are selectively rotated and the rotation directions of the one or more selected reels 30A to 30E are switched.

Specifically, the gaming machine includes; a game requiring a player's bet; reels 30A to 30E, for use in the game, which are mechanically driven to rotate and whose rotation directions are switchable; symbols 301 on each of the reels 30A to 30E; a display capable of generating a video image; a touch panel 69 disposed so that at least a part of a display area of the display is visible through the touch panel 69, and receives an input through a press operation by the player; and a controller which is programmed to carry out the following steps of (d1) to (d4).

Specifically, the controller is programmed to carry out the steps of: (d1) associating each of the reels 30A to 30E with a video image of a direction symbol 302 indicating a rotation direction of the reel, and displaying the video images; (d2) specifying an input position in the touch panel 69; (d3) when the input position corresponds to a display position of the direction symbols 302, determining that a rotation command related to one or more of the reels 30A to 30E is inputted; and (d4) rotating the one or more of the reels 30A to 30E associated with the direction symbol 302 in a rotation direction indicated by the direction symbol 302 while the rotation command is being inputted.

(Functional Block of the Gaming Machine)

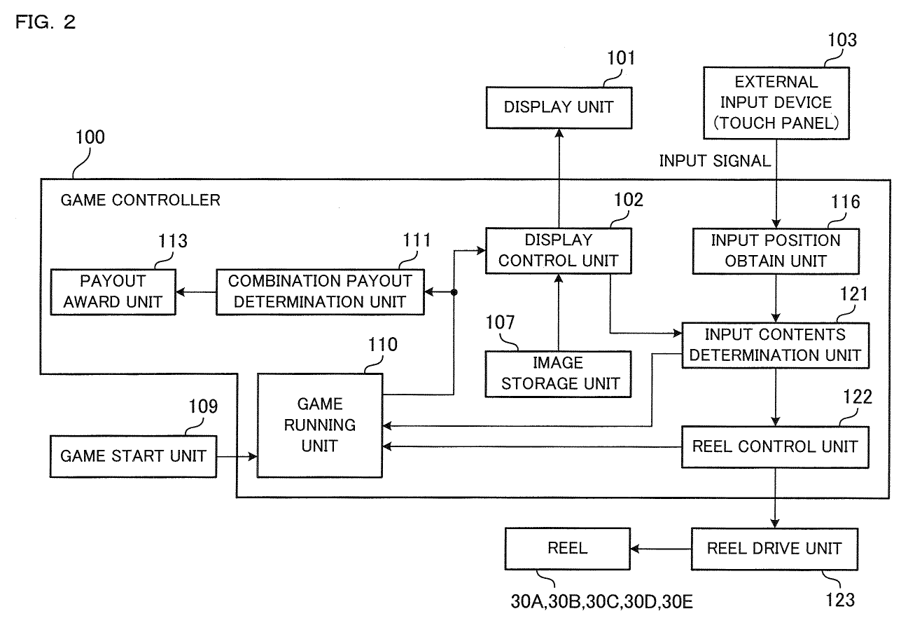

As shown in FIG. 2, the gaming machine with one of the above structures has a game controller 100, a display unit 101, an external input unit 103, a game start unit 109, a reel drive unit 123, and mechanical reels 30A to 30E.

(Display Unit 101)

The display unit 101 has functions of generating a video image and arranging/rearranging symbols 301 in a matrix with reels 30A to 30E. Note that the wording “arrange” a state where the symbols 301 can be visually observed by a player. To “rearrange” means that the symbols 301 are arranged again after releasing them.

The reels 30A to 30E of the display unit 101 may be partially substituted with a video reel displayed as an image. In other words, the display unit 101 may adopt a combination of mechanical (reel) and electrical (video reel) structures. Examples of an electrical structure are a liquid crystal display, a CRT (cathode-ray tube) device, a plasma display device, or the like.

(Game Controller 100)

The game controller 100 has an image storage unit 107 which stores image data such as a mini game screen, a help screen, or the like. The image storage unit 107 is accessed by a display control unit 102. The display control unit 102 reads various kinds of image data of the image storage unit 107 under the control of a game running unit 110. The display control unit 102 then displays various kinds of images related to the game in the display unit 101. A specific displaying mode is mentioned below.

The game controller 100 is connected to the game start unit 109. The game start unit 109 has a function of outputting a game start signal in response to a player's operation. The game controller 100 has a game running unit 110, a combination payout determination unit 111, and a payout award unit 113. The combination payout determination unit 111 determines a payout according to a combination of symbols 301 rearranged on a payline L in a unit game. The payout award unit 113 awards each payout determined in the combination payout determination unit 111.

The game running unit 110 has a function of running various kinds of games such as a basic game, a mini game, a free game, or the like. Moreover, the game running unit 110 has a function of running a unit game where symbols 301 are rearranged, triggered by a start signal from the game start unit 109.

Note that a unit game starts from receiving a bet and includes a series of operations until a win or loss is resulted. For example, a unit game of the basic game includes a bet time to receive a bet, a game time to rearrange stopped symbols 301, and a payout time of a payout process to award payout.

A basic game is a main game which the gaming machine is originally intended for, and is run during an ordinary game mode. For instance in slot machine 1, a slot game which is run during an ordinary game mode is a basic game. Note that a slot game offers a chance of acquiring a game value according to symbols 301 stopped and displayed after variable displaying of the symbols 301. Examples of a game value are a medal, a coin, a game ball, money, paper money, a magnetic card, or the like.

A mini game is a sub game different from the main game of the gaming machine. It is run in parallel with the basic game, or during a period of time while the basic game is not being played. In the present invention, for example, a penalty shootout game run during a slot game is a mini game. In the penalty shootout game, continuous penalty kicks may be automatically taken. This game may allow a player to operate kicking directions or strength of the ball.

A free game can be played for a predetermined number of times without betting a coin. Free game is a kind of bonus game. A bonus game is more advantageous than a basic game. Note that a bonus game is not specifically limited as long as it is an advantageous game for a player, that is, more advantageous than a basic game. Examples of a bonus game are, a state where more game media are obtainable than a basic game, a state where a possibility of obtaining a game medium is higher than that of the basic game, a state where fewer game media are consumed than a basic game, and so on.

The game controller 100 includes an input position obtain unit 116, an input content determination unit 121, and a reel control unit 122. The input position obtain unit 116 is connected to an external input unit 103. The external input unit 103 is disposed separately from the game controller 100, and receives a signal input from outside by a player. Although a touch panel is used as an external input unit 103 in the present embodiment, it is not limited to a touch panel. The external input unit 103 maybe a mouse or an operation button.

The input position obtain unit 116 has a function of specifying an input position based on a signal from the external input unit 103. The input content determination unit 121 has functions of: receiving an input position from the input position obtain unit 116 and determining a command based on a relation of the input position to the image display area in the display unit 101; and outputting a command signal corresponding to the command to the reel control unit 122 and the game running unit 110. More specifically, the input content determination unit 121 has a function of determining that, when the input position corresponds to a display position of a direction symbol, a rotation command related to a reel is inputted.

The game running unit 110 operates according to a command of a command signal. For example, when the command signal is a help command, it carries out a help process such as displaying a help screen as an image at a predetermined timing. Moreover, the reel control unit 122 enters an operation mode when the command signal is a rotation command related to the reels, and has a function of outputting a drive signal to the reel drive unit 123 to rotate reels 30A to 30E. Specifically, the reel control unit 122 has a function of outputting a drive signal to rotate at least one of the reels 30A to 30E in a rotation direction indicated by the associated direction symbol while the rotation command related to the one or more of the reels is being inputted.

Each block of the game controller 100 may be formed with hardware, or software as needed.

(Operation of Game Controller 100)

The following describes operations of the game controller 100. First, symbols 301 are arranged into a matrix of five columns and three rows in the display unit 101.

When the game running unit 110 runs a unit game through an operation by the game start unit 109, the reels 30A to 30E rotate and stop to rearrange the symbols 301. Then, the combination payout determination unit 111 determines a payout in accordance with a combination of symbols 301 rearranged on a payline, and the payout determined is awarded by the payout award unit 113.

When a player carries out a press operation to the external input unit 103, an input signal showing an input position in the external input unit 103 is outputted to the input position obtain unit 116. After extracting input position data included in the input signal in the input position obtain unit 116, the input signal is outputted to the input content determination unit 121. Afterwards, a command signified by the input signal is determined by comparing the input position data and a display area of the display unit 101. Then, a command signal including the command is respectively outputted to the game running unit 110 and the reel control unit 122.

When the game running unit 110 and the reel control unit 122 receive the command signal, they operate according to the command. For example, when the command is a reel rotation command through a player's operation, the reel control unit 122 is activated, and at least one of the reels 30A to 30E rotates in a rotation direction indicated by the associated direction symbol displayed on the display unit 101 while a rotation command related to the one or more of the reels is being inputted.

(Mechanical Structure)

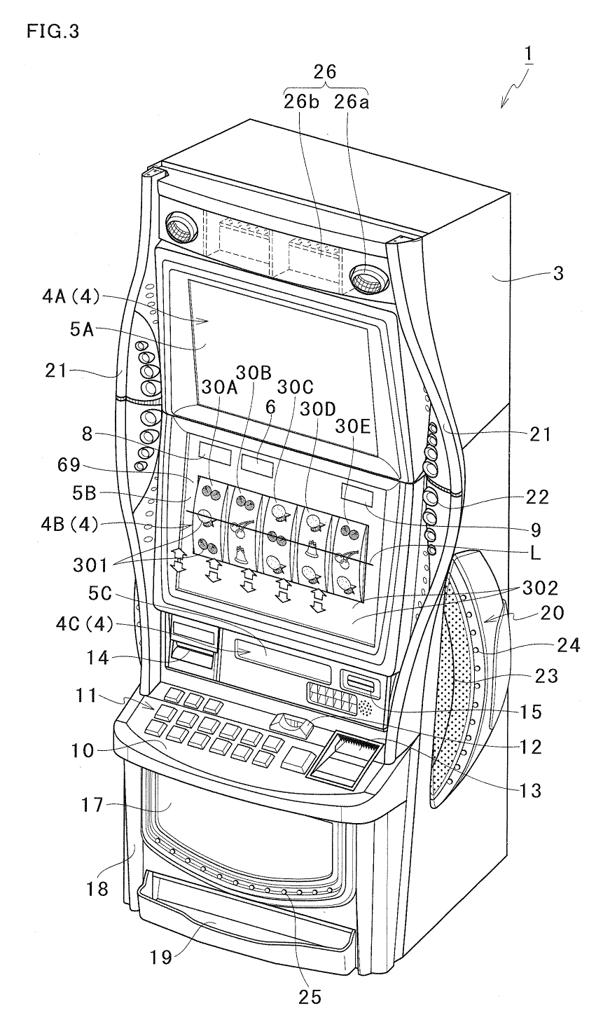

The following describes an embodiment where a gaming machine is specifically a slot machine 1. As shown in FIGS. 1 and 3, a slot machine 1 is an upright slot machine. The slot machine 1 has a cabinet 3 housing an electrical component and a mechanical component for running a predetermined game. The cabinet 3 has a longer length in the vertical direction. On the front side of the cabinet 3 facing a player is a display 4. The display 4 displays a basic game, a mini game, and game information based on a game operation by the player.

Specifically, the display 4 has an upper variable display unit 4A, a middle variable display unit 4B, and a lower variable display 4C. The upper variable display unit 4A has a transparent upper liquid crystal panel 5A. The upper liquid crystal panel 5A is fixed on a front door of the cabinet 3. The upper liquid crystal panel 5A displays a soccer game screen or a penalty kick standby screen during basic, mini, and free games. In other words, the upper liquid crystal panel 5A displays a soccer game screen when the mini game is not running, and a penalty kick standby screen while the mini game is running.

The middle variable display unit 4B is a rotation symbol display panel on which a player directs the eyes at all times. The middle variable display unit 4B has a transparent central liquid crystal panel 5B fixed on the front door of the cabinet 3. The central liquid crystal panel 5B has five display windows 7A to 7E presenting an internal state to the outside. Inside the display windows 7A to 7E, are reels 30A to 30E respectively arranged.

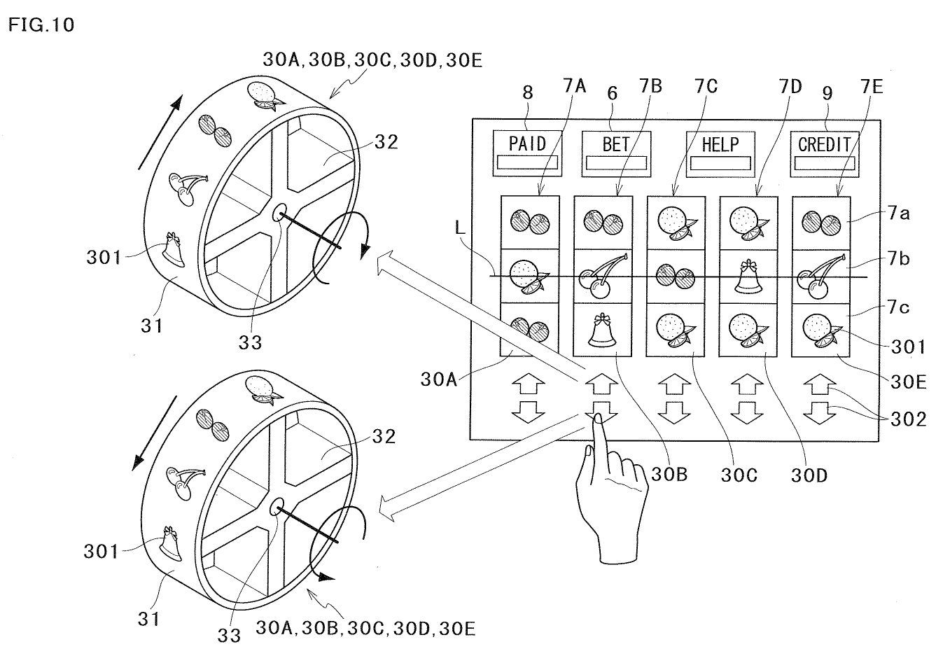

As shown in FIG. 10, each of the reels 30A, 30B, 30C, 30D, and 30E has a circular cylindrical member 31, a rotation axis 32 arranged at the center of the cylindrical member 31, and a support member 33 which communicates the rotation axis 32 and the cylindrical member 31. The rotation axis 32 communicates with a rotation drive mechanism (not shown). The rotation drive mechanism enables the reels 30A to 30E to rotate and stop at a predetermined angle by providing a rotation drive force to the rotation axis 32 at any given timing.

On the outer cabinet surface of the cylindrical member 31 is a symbol column. The symbol column has a combination of symbols 301, including a “JACKPOT 7,” a “BLUE 7,” a “BELL,” a “CHERRY,” a “STRAWBERRY,” a “PLUM,” an “ORANGE,” and an “APPLE.” Moreover, the symbol column is set so that three successive symbols 301 on the symbol column are visible through associated one of the display windows 7A, 7B, 7C, 7D, and 7E.

The reels 30A to 30E described above enable the symbol columns to respectively rotate in a vertical direction through mechanical drive. Thus, the slot machine 1 is capable of rearranging five columns and three rows of symbols 301 in display windows 7A to 7E by rotating and stopping the reels 30A to 30E.

The central liquid crystal panel 5B displays one payline L. The payline L horizontally crosses the five display windows, 7A to 7E. Note that the payline is for determining a combination of the symbols 301. In other words, when symbols 301 are rearranged on and outside the payline L, only a combination of the symbols 301 rearranged on the payline L is considered. When the combination is recognized as a winning combination, a process such as paying out a coin according to the winning combination or the like is carried out.

The central liquid crystal panel 5B displays a moving image effect or the like in an effect display unit when a player wins a game. The central liquid crystal panel 5B also displays, on its upper area, images of a bet display unit 6, a payout display unit 8, and a credit display unit 9. The entire surface of the central liquid crystal panel 5B is covered with the touch panel 69. The touch panel 69 is made of a transparent material including a transparent electrode or the like. Through the touch panel 69, an image of the each display unit displayed by the central liquid crystal panel 5B, and the symbols 301 on the reels 30A to 30E are visible. Thus, the images on the central liquid crystal panel 5B and the symbols 301 on the reels 30A to 30E are visible to the player through the touch panel 69.

In addition, the touch panel 69 has a function of outputting, as an input signal, two-dimensional position data of horizontal axis and vertical axis directions when receiving a pressing force. Hence, through the touch panel 69, the each display unit of the central crystal panel 5B and the reels 30A to 30E are visible to the player. Moreover, the touch panel 69 outputs, to a below mentioned main body PCB 260, an input signal including information indicated by the each display unit when the player presses the each display unit.

The lower variable display unit 4C has a lower liquid crystal panel 5C which displays a point stored in a card, or a point of a game. A number displayed on the lower liquid crystal panel 5C is based on a result displayed of the middle variable display unit. When a winning combination is formed on the middle variable display unit 4B, a point based on the winning combination is added to the game point/s displayed on the lower liquid crystal panel 5C. On the left side of the lower liquid crystal panel 5C is a ticket printer 14. On the right side of the lower liquid crystal panel 5C is a card reader 15.

Below the lower variable display unit 4C is an operation table 10. The operation table 10 projects forward from the front surface of the cabinet 3. The operation table 10 has an operation button 11. The operation button 11 is structured with, for instance, a bet button, a collect button, a start button, a stop button, or the like. The operation table 10 also has a coin insertion slot 12 and a paper money insertion slot 13. With the above structure, the operation table 10 functions as an operation unit enabling a player to carry out game related operations.

Below the operation table 10 is a waist panel 17. The waist panel 17 is a plastic panel on which an image related to a game is printed. The waist panel 17 is fixed on a lower front door 18, and is illuminated by a cold cathode tube. Below the waist panel 17 is a coin receiving portion 19. The coin receiving portion 19 is formed so as to store the coins paid out according to the game result.

The cabinet 3 has a light emitting section 20. The light emitting section 20 includes light emitting components such as lamps, LED, or the like. The light emitting section 20 is formed and disposed so as to surround a game area including the upper variable display unit 4A, the middle variable display unit 4B, the lower variable display unit 4C, and the operation table 10.

The lamps in the light emitting section 20 are a side lamp 22, a speaker lamp 24, an under lamp 25, a top lamp 26, or the like. The side lamps 22 are disposed to inclined units 21. These inclined units 21 are respectively disposed to the left and the right sides of the front surface side of the cabinet 3. The inclined units 21 are projected in bow shapes, and are disposed so as to sandwich the upper variable display unit 4A, the middle variable display unit 4B, the lower variable display unit 4C.

The speaker lamps 24 are projected sideways at the right and left ends of the cabinet 3 adjacent to the operation table 10. The speaker lamps 24 are provided on arc-shaped speakers 23, and are aligned along edges of the speakers 23. The under lamps 25 are provided on the lower front door 18, and are aligned along a lower edge of the waist panel 17. The top lamp 26 is provided above the upper variable display unit 4A. The top lamps 26 has power lamps 26a arranged at both sides respectively and a band-type lamp 26b horizontally arranged between the power lamps.

(Electrical Structure)

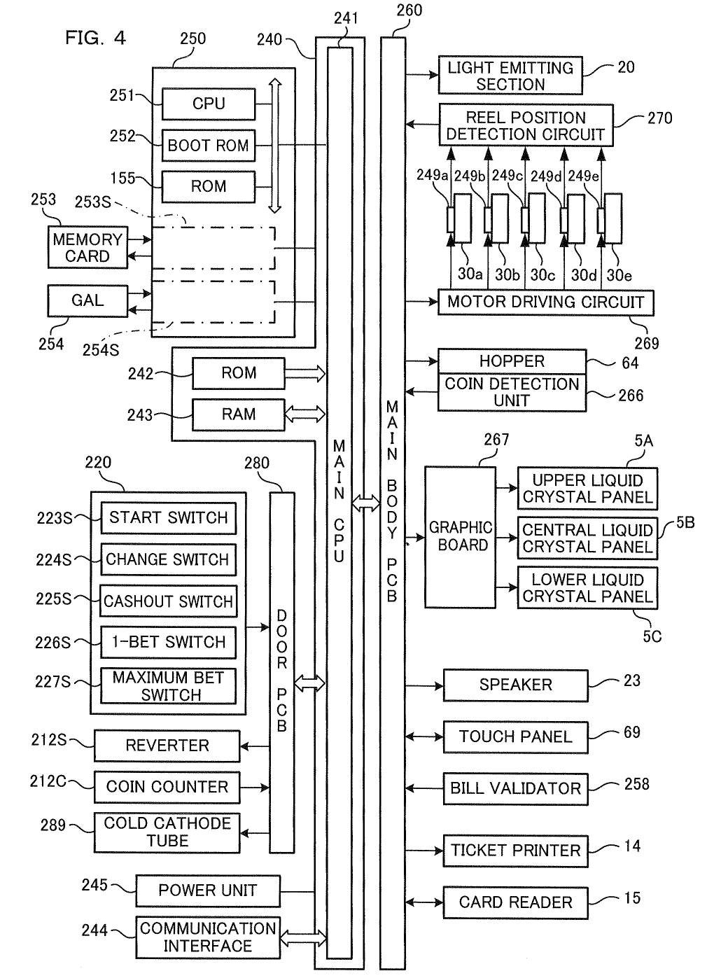

FIG. 4 is a block diagram showing an electrical structure of the entire slot machine 1. A control unit having a controller 100 shown in FIG. 2 is disposed inside the cabinet 3. As shown in FIG. 4, the control unit has such components as a motherboard 240, a main body PCB (Printed Circuit Board) 260, a gaming board 250, a door PCB 280, various kinds of switches, a sensor, or the like.

The gaming board 250 has a CPU (Central Processing Unit) 251, a ROM 255, a boot ROM 252, a card slot 253S corresponding to a memory card 253, and an IC socket 254S corresponding to a GAL (Generic Array Logic) 254, connected to one another through an internal bus.

The memory card 253 stores a game program and a game system program. The game program includes a stop symbol determination program. The stop symbol determination program is for determining the symbols 301 to be stopped on the payline L (a code number corresponding to the symbols). The stop symbol determination program includes symbol weighing data corresponding to each of kinds of payout rates (e.g. 80%, 84%, and 88%). The symbol weighting data shows a corresponding relationship between a code number of each symbol and one or more random number values in a predetermined value range (0 to 256), for each of the display windows 7A, 7B, 7C, 7D, and 7E.

The memory card 253 stores a program which samples a random number. The random number sample program is loaded into a RAM 243 in time of carrying out a game running process, a bonus game process, or the like. This program is run by a main CPU 241. A random number is sampled by a program in the present embodiment; however, the method of sampling a random number is not limited to this. For example, it is possible to adopt a structure including: a random number generating circuit which generates a random number (random numbers) of a certain range, and a sampling circuit which samples a random number from the random number(s) generated by the random number generating circuit.

A payout rate is set according to the payout rate setting data outputted from the GAL 254. Symbols to be stopped are determined according to the symbol weighed data corresponding to the payout rate.

The memory card 253 stores various kinds of data used in the game program and the game system program. For example, the data showing a relationship between the random number range and the symbols 301 displayed in the display windows 7A to 7E in FIG. 1, is stored as a table in the memory card 253. The data is transferred to the RAM 243 of the motherboard 240 in time of running the game program.

The memory card 253 is attachable/detachable to/from the card slot 253S. The card slot 253S is connected to the motherboard 240 by an IDE bus. Thus, the gaming board 250 enables a player to change the types and contents of games to be run in the slot machine 1 through an switching operation including the steps of removing the memory card 253 from the card slot 253S, writing a different game program and a game system program in the memory card 253, and inserting the memory card 253 to the card slot 253S.

The game program includes a program according to a game progress, and a program for shifting into a bonus game. The game program also includes image data and sound data outputted during a game.

The GAL 254 has input ports and output ports. When data is inputted to the input ports, the GAL 254 outputs, from the output ports, the data corresponding to the inputted data. The data outputted from the output ports is the above-mentioned payout rate setting data.

The GAL 254 is attachable/detachable to/from the IC socket 254S. The IC socket 254S is connected to the motherboard 240 by a PCI bus. Thus, the gaming board 250 enables the payout rate setting data outputted from the GAL 254 to be changed through an switching operation including the steps of removing the GAL 254 from the IC socket 254S, rewriting a program stored in the GAL 254, and attaching the GAL 254 to the IC socket 254S.

The CPU 251, ROM 255, and boot ROM 252 connected to one another by an internal bus, are connected to the motherboard 240 by a PCI bus. The PCI bus transmits a signal between the motherboard 240 and the gaming board 250. The PCI bus also supplies power to the gaming board 250 from the motherboard 240. The ROM 255 stores country identification information and an authentication program. The boot ROM 252 stores a preliminary authentication program, a program for the CPU 251 to start the preliminary authentication program (boot code), or the like.

An authentication program is for authenticating a game program and a game system program (modification check program). The authentication program is for confirming and authenticating that the game program or the game system program is not modified. In other words, the authentication program is described in accordance with the authentication procedure of the game program and the game system program. A preliminary authentication program is for authenticating the authentication program. The preliminary authentication program is described in accordance with a procedure for verifying that the authentication program to be authenticated is not falsified. In short, the preliminary authentication program authenticates the authentication program.

The motherboard 240 has a main CPU 241(controller), a ROM (Read Only Memory) 242, a RAM (Random Access Memory) 243, and a communication interface 244.

The main CPU 241 functions as a controller to control the entire slot machine 1. Specifically, the main CPU 241 controls (i) when the start button is pushed after a credit is bet, to output a command signal to rotate and stop the reels 30A to 30E to start a variable display in the display windows 7A to 7E, (ii) after a variable display has started, to determine the symbols to be stopped, and (iii) to still-display the determined symbols in the display windows 7A to 7E.

In other words, the main CPU 241 functions as an arrangement controller for carrying out an arrangement control by which, among various kinds of symbols 301, the symbols to be stopped in a symbol matrix are selected and determined, and then scrolling of the symbols is stopped so that the determined symbol matrix appears. With this function, symbols 301 displayed after being scrolled by a rotation of the reels 30A, 30B, 30C, 30D, and 30E on the central liquid crystal panel 5B are rearranged in a new symbol matrix.

The ROM 242 stores a program such as BIOS (Basic Input/Output System) or the like run by the main CPU 241. The ROM 242 also stores data which is permanently used. When the main CPU 241 runs the BIOS, each peripheral device is initialized, and a reading process via the gaming board 250 for a game program and a game system program stored in the memory card 253, is started. The RAM 243 stores data and a program used when the main CPU 241 carries out the process.

The communication interface 244 is for communicating, through a telecommunication circuit, with a host computer or the like provided in the arcade. The main body PCB (Printed Circuit Board) 260 and the door PCB 280 are respectively connected with the motherboard 240 through a USB (Universal Serial Bus). Moreover, the motherboard 240 is connected to a power unit 245. The power unit 245 supplies power to the motherboard 240 to boot the main CPU 241 of the motherboard 240, and supplies power to the gaming board 250 through the PCI bus to boot the CPU 251.

The main body PCB 260 and the door PCB 280 are connected to equipment or a device which generates an input signal to be inputted into the main CPU 241, and equipment or a device whose operation is controlled by a control signal outputted from the main CPU 241. The main CPU 241 runs a game program and a game system program stored in the RAM 243 in accordance with the input signal inputted to the main CPU 241. Thus, the main CPU 241 is capable of carrying out various kinds of processes such as storing a result of a calculation process to the RAM 243, and controlling each equipment and device by transmitting a control signal to the each equipment and device.

The main body PCB 260 is connected to a light emitting section 20, a hopper 64, a coin detection unit 266, a graphic board 267, the speakers 23, a bill validator 258, the ticket printer 14, and the card reader 15. The light emitting section 20 has lamps including the side lamps 22, the speaker lamps 24, the under lamps 25, the top lamps 26 and an LED.

Turning on and off the light emitting section 20 is controlled according to a control signal outputted by the main CPU 241. The hopper 64 is disposed in the cabinet 3, and pays out a predetermined number of coins from a coin payout opening 16 to the coin receiving portion 19 in accordance with a control signal outputted by the main CPU 241. The coin detection unit 266 is disposed in the coin payout opening 16. When the coin detection unit 266 outputs an input signal to the main CPU 241 upon detecting that a predetermined number of coins have been paid out from the coin payout opening 16.

The coin detection unit 266 counts the number of coins paid out by the hopper 64, and outputs the data of the resulting number to the main body PCB 260. According to the data of the number of coins paid out (by the hopper 64), the main body PCB outputs a signal to notify completion of payout of a coin or coins to the main CPU 241, when a set number of coins are paid out.

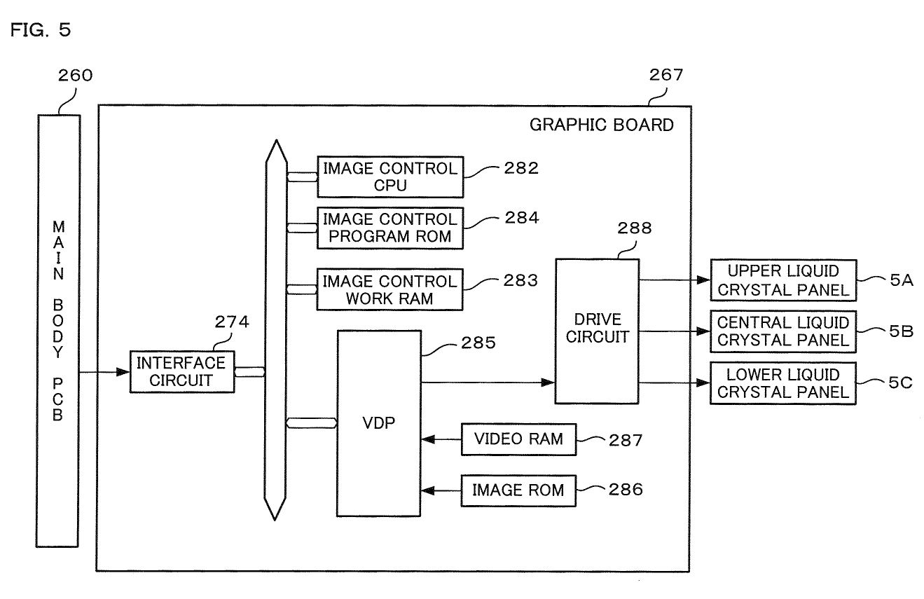

The graphic board 267 controls display of an image on the upper liquid crystal panel 5A, the central liquid crystal panel 5B, and the lower liquid crystal panel 5C, in accordance with a control signal outputted from the main CPU 241. As shown in FIG. 5, the graphic board 267 has an interface circuit 281, an image control CPU 282, an image control work RAM 283, an image control program ROM 284, a VDP (Video Display Processor) 285, an image ROM 286, a video RAM 287, and a drive circuit 288.

The image control CPU 282 receives a control signal outputted from the main CPU 241 via the interface circuit 281. In response to the control signal from the main CPU 241, the image control CPU 282 runs the image control program stored in the image control program ROM 284 to determine an image to be displayed on the upper liquid crystal panel 5A, the central liquid crystal panel 5B, and the lower liquid crystal panel 5C.

The image control program ROM 284 stores various kinds of selection tables and an image control program related to displays on the upper liquid crystal panel 5A, the central liquid crystal panel 5B, and the lower liquid crystal panel 5C. The image control work RAM 283 functions as a temporary storage means when the image control CPU 282 runs the image control program.

The VDP 285 forms image data corresponding to a determination made in the image control CPU 282. The image ROM 286 stores dot data for forming an image such as a symbol 301. The video RAM 287 functions as a temporary storage means when an image is formed in the VDP 285. The drive circuit 288 outputs image data formed by the VDP 285 to the upper liquid crystal panel 5A, the central liquid crystal panel 5B, and the lower liquid crystal panel 5C. The image data used when the VDP generates image data is stored in the memory card 253, and is included in the game program read by the memory card 253 and temporarily stored in the RAM 243.

As shown in FIG. 4, the speakers 23 generate various kinds of sound effects when various kinds of effects are applied according to an output signal from the main body PCB 260. The bill validator 258 carries out at least the following processes: a process of reading an image of a bill, a process of determining whether or not the bill is genuine, and a process of, when the bill is genuine, accepting the bill into the cabinet 3. Moreover, when the bill validator 258 accepts a genuine bill, the bill validator outputs an input signal indicating the value of the accepted paper money to the main CPU 241. The main CPU 241 stores, in the RAM 243, a credit/credits corresponding to the value of paper money transmitted by the input signal.

According to a control signal outputted by the main CPU 241, the ticket printer 14 prints a barcode on a ticket, and then outputs the ticket with a barcode. The barcode contains encoded data of credits stored in the RAM 243, date and time, an identification number of the slot machine 1, or the like. The card reader 15 reads data from a smart card and transmits the data to the main CPU 241. In addition, the card reader 15 writes data into a smart card according to a control signal from the main CPU 241.

The main body PCB 260 is connected to a motor driving circuit 239 and a reel position detection circuit 270. The motor driving circuit 239 is connected to stepping motors 249a, 249b, 249c, 249d, and 249e. With the pulsed power supplied by the motor driving circuit 239, the stepping motors 249a to 249e respectively rotate the reels 30A to 30E at any given rotation speed, and position the reels 30A to 30E.

The reel position detection circuit 270 receives a pulse signal from a reel rotation sensor. In response to the pulse signal, the reel position detection circuit 270 outputs, to the main body PCB 260, a reel position signal to detect a position of the each reel 30A to 30E. The reel position signal is assigned to a code number of a below mentioned data table for a symbol, so as to enable detection of a rotation angle of the reels 30A to 30E, and rearranging of specified symbols 301 in specific positions.

The door PCB 280 is connected to a control panel 220, a reverter 212S, a coin counter 212C, and a cold cathode tube 289. In the control panel 220 are a switch 223S corresponding to the start button, a change switch 224S corresponding to a change button, a cash-out switch 225S corresponding to a cash-out button, a 1-bet switch 226S corresponding to a 1-bet button, and a maximum bet switch 227S corresponding to a maximum bet button. Each of the switches 223S to 227S outputs an input signal to the main CPU 241 when the player presses corresponding one of the buttons.

The coin counter 212C is disposed inside the coin insertion slot 12, and validates whether or not the coin inserted by the player to the coin insertion slot 12 is genuine. Anything other than a genuine coin is discharged to the coin receiving tray 16. The coin counter 212C outputs an input signal to the main CPU 241 when detecting a genuine coin.

The reverter 212S operates in accordance with the control signal outputted by the main CPU 241. The reverter 212S distributes a coin recognized as genuine by the coin counter 212C to a cash enclosure (not shown) or the hopper 64 disposed inside the slot machine 1. That is, when the hopper 64 is filled with coins, the genuine coin will be distributed to a cash enclosure by the reveter 212S. To the contrary, when the hopper 64 is not filled with coins, the genuine coin will be distributed to the hopper 64. The cold cathode 289 functions as a backlight mounted to rear sides of the upper liquid crystal panel 5A, the central liquid crystal panel 5B, and the lower liquid crystal panel 5C. The cold cathode 289 lights up in accordance with a control signal outputted by the main PCU 241.

(Symbol, Combination, or the Like)

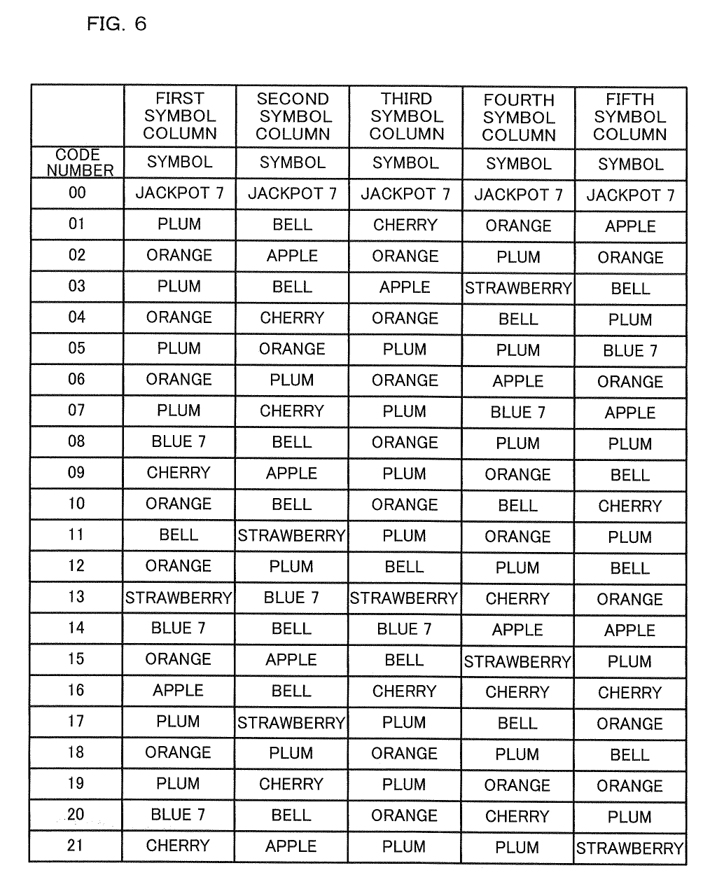

The symbols 301 displayed in the display windows 7A to 7E of the slot machine 1 forms symbol columns, each of which having twenty-two symbols. As shown in FIG. 6, one of code numbers 0 to 21 is assigned to each of the symbols constituting each column. Each of the symbol columns is constituted with a combination of symbols of “JACKPOT 7,” “BLUE 7,” “BELL,” “CHERRY,” “STRAWBERRY,” “PLUM,” “ORANGE,” and “APPLE.”

Three successive symbols in each of the symbol columns are respectively displayed (arranged) on an upper stage 7a, a middle stage 7b, and a lower stage 7c of each of the display windows 7A, 7B, 7C, 7D, and 7E, to form a symbol matrix of five columns and three rows. When the start button is pressed to start a game after the bet button is pressed, the symbols forming a symbol matrix start scrolling. This scrolling of the symbols stops after a predetermined period from the beginning of the scrolling (rearrange).

Various kinds of winning combinations are set in advance for each symbol. A winning combination is a combination of stopped symbols on the payline L which puts the player in an advantageous state. Examples of an advantageous state include: a state where coins according to a winning combination is paid out, a state where the number of coins to be paid out is added to a credit, a state where a bonus game is started.

For example, a combination on the payline L including an “APPLE” symbol serves as a bonus trigger which causes a transition of a gaming mode from a basic game to a bonus game. Further, when a combination including a “CHERRY” symbol is formed on the payline L in a basic game, twenty coins (values) are paid out for one bet. When a combination including a “PLUM” symbol is formed on the payline L in a basic game, five coins are paid out for one bet.

Here, a bonus game is a gaming state which provides a larger advantage than a base game. Note that another bonus game may be employed in combination, provided that the other bonus game is advantageous to a player, i.e., the other bonus game is more advantageous than a basic game. For example, a bonus game may be a state where more coins are possibly obtained than the basic game, a state where the probability of obtaining coins is higher than in the basic game, a state where fewer coins are consumed than the basic game, free game, or the like.

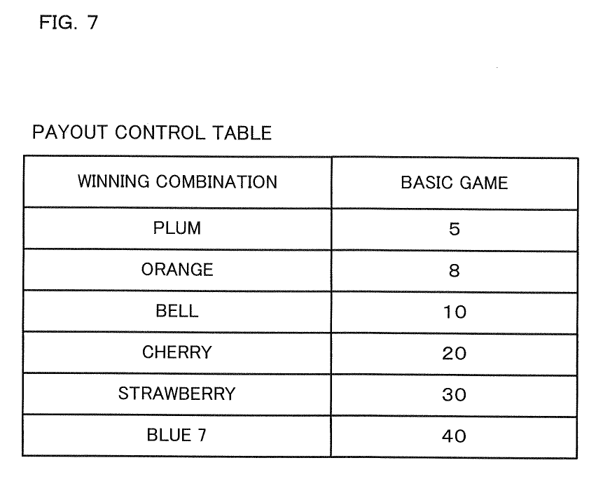

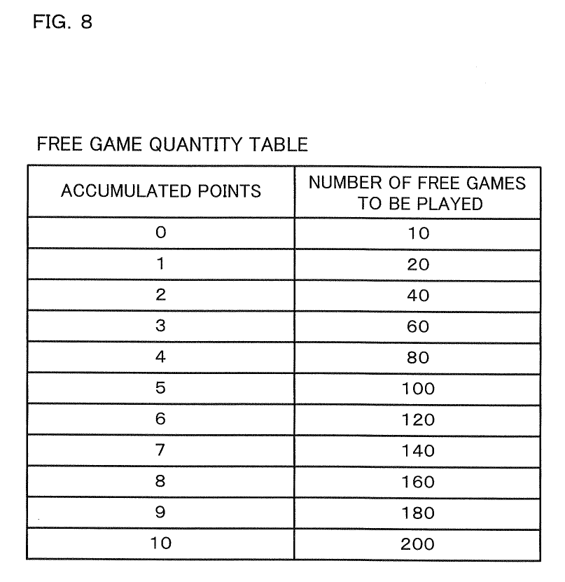

The following describes each table stored in the ROM 242 of a main control board 71, with reference to FIGS. 7 and 8.

(Payout Control Table)

FIG. 7 is a payout control table which controls a payout awarded in accordance to a winning combination. The payout control table is stored in the ROM 242 of the main control board 71, and a piece of information of a payout is assigned to a type of winning combination. For example, a payout for a winning combination including a “BELL” symbol is “10.” A payout for a winning combination including a “BLUE 7” is “40.” Note that payouts for a basic game and a free game are set to be the same in the present embodiment

(Free Game Quantity Table)

FIG. 8 is a table referred to when determining the number of free games to be played for the number of points acquired in a mini game of a basic game. The points awarded in a mini game correspond to the number of free games to be played in the free game quantity table. For example, when the total number of accumulated points is 4, the free games are run eighty (80) times. When the total number of accumulated points is 8, the free games are run a hundred sixty (160) times. Thus, by succeeding in a mini game in a basic game and acquiring many points, it is possible to continue a free game for a long period of time.

(Display State)

The following specifically describes an example of a display state of the display 4 in an operation of the slot machine 1.

(Help Mode Screen)

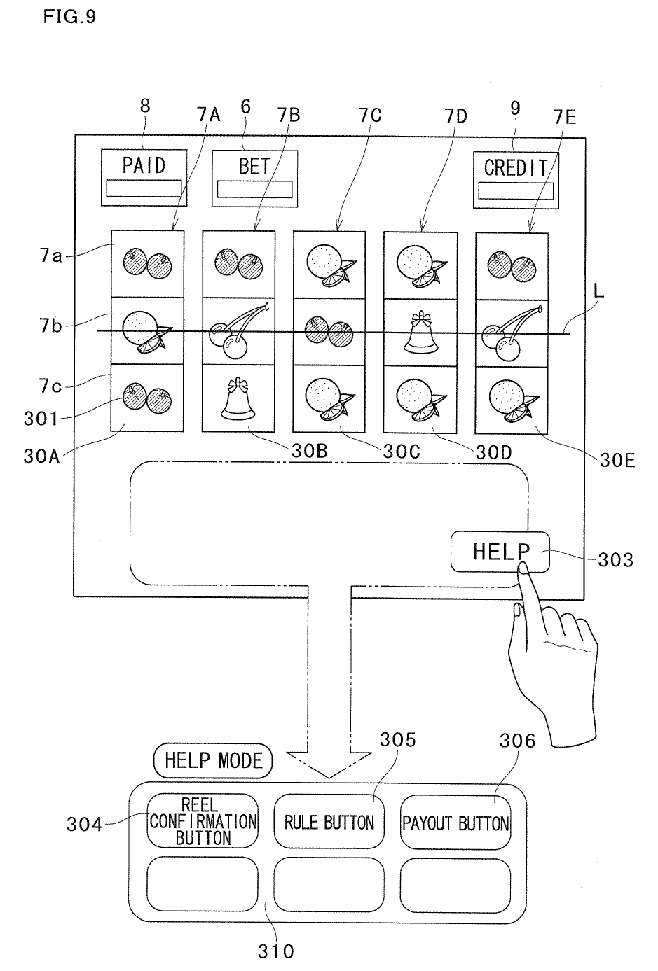

FIG. 9 shows a display state of the display 4 when modes switches from a game mode to a help mode. That is, the bet display unit 6, the payout display unit 8, and the credit display unit 9 are displayed in the upper part of the central liquid crystal panel 5B constituting a part of the display 4. In addition, in the center of the central liquid crystal panel 5B, window frames of the display windows 7A to 7E are displayed. When a basic game or a free game starts, all the symbols 301 on the reels 30A to 30E visible through the display windows 7A to 7E are variably displayed.

Moreover, in the lower part of the central liquid crystal panel 5B, a help button 303 is displayed. The help button 303, upon being pressed, activates the help mode. The help mode provides a player with troubleshooting information regarding a game.

A help mode screen has a help button frame 310 arranged below the display windows 7A to 7E. The help button frame 310 has a reel confirmation button 304, a rule button 305, and a payout button 306 inside. The reel confirmation button 304 is for activating a reel confirmation mode which enables a player to confirm the symbols 301. The rule button 305 is for activating a rule guidance mode which provides a player with an introduction to a game or guidance on a method of playing a game. The payout button 306 is for activating a payout guidance mode which provides a player with guidance on payouts.

(Reel Confirmation Mode Screen)

FIG. 10 shows a display mode of the display 4 during a reel confirmation mode. That is, in the lower part of the central liquid crystal panel 5B constituting a part of the display 4, direction symbols 302 are displayed. Each of the direction symbols 302 has an arrow shape. One direction symbol and another paired with the former are symmetrically disposed so that one points out the upward direction and the other, the downward direction. Each pair of upper and lower direction symbols 302 are arranged below each of the display windows 7A to 7E. These pairs of direction symbols 302 function as command buttons to output a command to rotation drive each of the reels 30A to 30E in upward or downward directions.

Thus, pressing of a direction symbol 302 pointing an upward direction causes upward rotation of at least one of the corresponding reels 30A, 30B, 30C, 30D, and 30E positioned above the direction symbols 302. On the other hand, pressing of a direction symbol 302 pointing a downward direction causes downward rotation of, at least one of the reels 30A, 30B, 30C, 30D, and 30E corresponding to the direction symbol 302.

(Mini Game Screen)

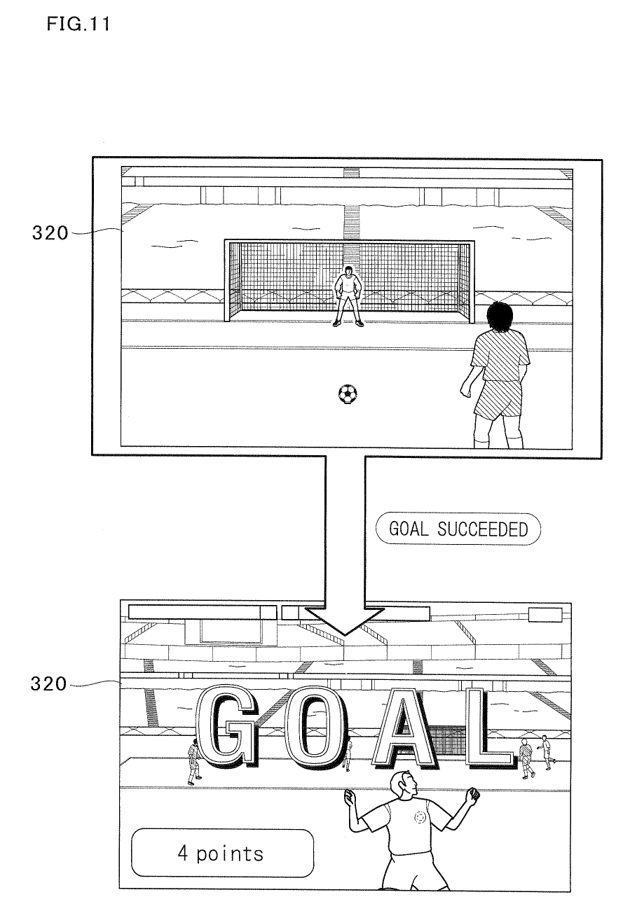

FIG. 11 shows a display state of the display 4 during a mini game. In other words, when a mini game starts, a mini game screen 320 is displayed on the entire upper liquid crystal panel 5A. A mini game screen 320 shows a penalty shootout of a soccer game. Specifically, a kicker who kicks a ball and a goal keeper who defends a goal are displayed as an initial screen. After a predetermined standby time, the kicker kicks the ball. When the ball goes into the goal, an image reading “GOAL” and the total number of accumulated points is displayed. This allows a player to confirm the points acquired. To the contrary, when the ball does not go into the goal, the screen goes back to an initial screen of a next penalty shootout. Note that there will be no points generated in this case.

(Process Operation of the Slot Machine 1: Booting Process)

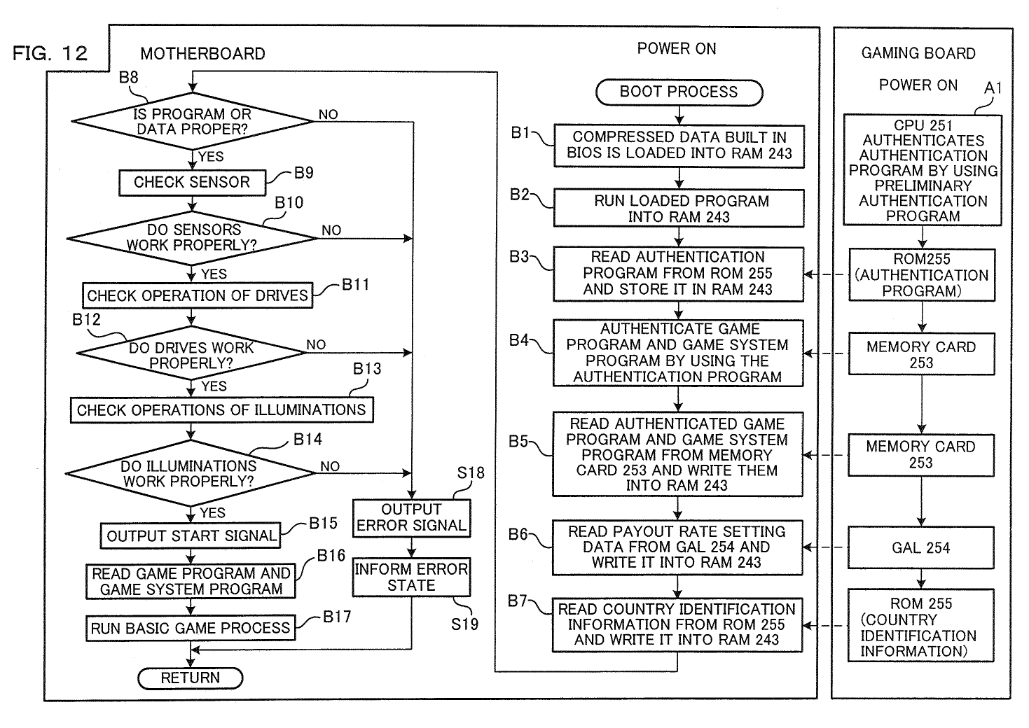

The following describes a booting process taking place in the slot machine 1. When power is supplied to the slot machine 1, a booting process routine shown in FIG. 12 takes place in the motherboard 240 and the gaming board 250. In the present embodiment, a memory card is inserted into the card slot 253S of the gaming board 250, and the GAL 254 is attached to the IC socket 254S.

First, when a power switch is turned on (power is supplied) in the power unit 245, the motherboard 240 and the gaming board 250 are booted. When the motherboard 240 and the gaming board 250 are booted, different processes are respectively carried out in parallel. That is, in the gaming board 250, the CPU 251 carries out processes of reading a preliminary authentication program stored in the boot ROM 252, and carrying out preliminary authentication by the preliminary authentication program. Note that the preliminary authentication is a process in which the preliminary authentication program is run to confirm and authenticate that authentication program is not modified in advance before importing the program into the motherboard 240 (A1).

Meanwhile, in the motherboard 240, the main CPU 241 runs BIOS stored in the ROM 242. As a result, the compressed data built in the BIOS is loaded into the RAM 243 (B1). Then, the main CPU 241 runs the BIOS loaded into the RAM 243, and diagnoses and initializes various kinds of peripheral devices (B2).

Afterwards, the main CPU 241 reads, via PCI bus, the authentication program stored in the ROM 255, and stores the read authentication program to the RAM 243 (B3). During this step, the main CPU 241 drives a checksum through an ADDSUM method (a standard check function) which is adopted in standard BIOS. Thus, it is confirmed whether or not the authentication program is stored in the RAM 243 without an error.

The main CPU 241 then confirms a component connected to the IDE bus. Then, the main CPU 241 accesses to the memory card 253 inserted into the card slot 253S via the IDE bus, to read the game program and the game system program from the memory card 253. In this case, data constituting the game program and the game system program are read in units of four bytes. Then, the main CPU 241 confirms and authenticates, according to the authentication program stored in the RAM 243, that the read game program and the game system program are not modified (B4).

When the authentication process ends properly, the main CPU 241 writes and stores the authenticated game program and the game system program in the RAM 243 (B5).

The main CPU 241 then accesses to the GAL 254 attached to the IC socket 254S to read payout rate setting data from the GAL 254, and stores the data in the RAM 243 (B6). Afterwards, the main CPU 241 reads the country identification information stored in the ROM 255 of the gaming board 250, and stores the information to the RAM 243 (B7).

With a result of the above authentication process, the main CPU 241 determines whether the program or data is proper (B8). When the program or data is not proper (B8, NO), an error signal including ID information to specify a slot machine 1 is outputted to a centralized control device (not shown). The centralized control device specifies a slot machine 1 in an error state based on the error signal. The centralized control device then instructs a staff standing by near the slot machine 1 to deal with the error, and stores an error history information containing a time and date and a place when/where the error has occurred, or the like (B18). Then, the error state is informed in the form of an audio output from the speaker 23 of the slot machine 1, and in the form of light emitted from the light emitting section 20. Afterwards, the routine in the motherboard 240 ends.

On the other hand, when the program or data is proper (B8, YES), operations of sensors disposed to the slot machine 1 are checked successively (B9). Then, whether or not all the sensors operate properly is determined (B10). When an error is detected in at lest one sensor (B10, NO), the above mentioned B18 and B19 are carried out, and the routine ends thereafter.

On the other hand, when all the sensors operate properly (B10, Yes), operations of all drive mechanisms are checked successively (B11). Then, it is determined whether or not all the drive mechanisms operate properly (B12). When an error is detected in at least one drive mechanism (B12, NO), the above mentioned B18 and B19 are carried out, and the routine ends thereafter. On the other hand, when all the drive mechanisms operate properly (B12, Yes), operations of all illuminations are checked successively (B13). Then, it is determined whether or not all the illuminations operate properly (B14). When an error is detected in at least one illumination (B14, No), the above mentioned B18 and B19 are carried out, and the routine ends thereafter.

On the other hand, when all the illuminations operate properly (B14, Yes), a boot signal indicating that all the illuminations have been booted properly is outputted to the centralized control device (not shown) or the like (B15). Afterwards, a basic game process is carried out (B16), and this routine ends. The following describes a basic game process in detail.

(Basic Game Process)

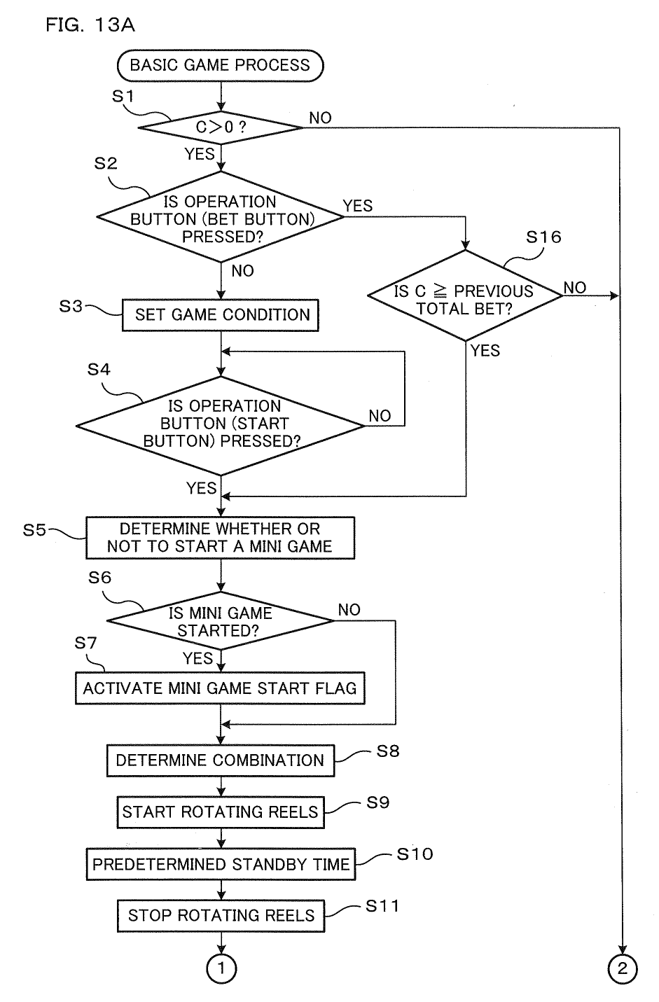

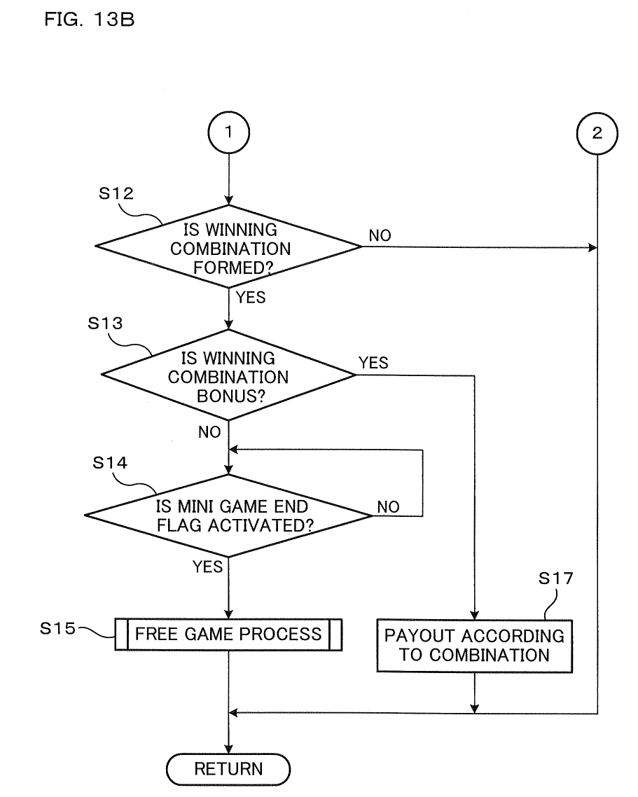

FIGS. 13A and 13B are flow charts showing a process carried out by the main CPU 241 of the slot machine 1 during a basic game of the slot machine 1. A unit game includes a routine shown in FIGS. 13A and 13B. Note that the slot machine 1 is booted in advance, and a variable used in the CPU 241 on the other side, i.e. in the game controller 1 side, is initialized at a predetermined value. Accordingly, the slot machine 1 is constantly operated.

First, it is determined if there is a remaining credit, i.e., the remaining number of coins having been inserted by the player (S1). Specifically, a credit C stored in the RAM 243 is read, and a process according to the read credit C is carried out. When the credit C is zero (S1, NO), the routine ends without any operation of a process since a game cannot be started. Meanwhile, when the credit C is equal to or more than one (S1, Yes), it is determined that there is at least one credit remaining and the process moves to S2.

In S2, it is determined whether or not the operation button 11 (bet button) is pressed (S2). When the operation button 11 (bet button) is not pressed for a predetermined time (S2, NO), a game condition is set (S3). Specifically, the number of coins to be bet on the payline L in the game is determined according to the operation of the operation button 11 (bet button). During this operation, an operation signal sent upon an operation of the operation button 11 is received. According to the number of times that the operation signal is received, the bet on the payline L is stored in a predetermined memory area of the RAM 243. Then, the credit C written into the predetermined memory area of the RAM 243 is read. A total bet where the above bet is added is subtracted from the read credit C. The resulting number is stored in the predetermined memory area of the RAM 243.

Afterwards, it is determined whether or not an operation button 11 (start button) is pressed (S4). When the operation button 11 (start button) is not pressed (S4, NO), S4 is repeated until the bet button 11 is pressed. When the operation button 11 (start button) is pressed (S4, YES), it is determined whether or not to start a mini game (S5).

On the other hand, when the operation button 11 (bet button) is pressed in S2 (S2, YES), it is determined whether or not a value of the credit C is equal to or more than the value of the total bet in the previous game. In other words, it is determined whether or not it is possible to start a game with the operation button 11 (bet button) being pressed. Specifically, pressing of the operation button 11 (bet button) causes reading out of a bet on the payline L in the previous game and a credit C written in a predetermined memory area of the RAM 243. According to a relation of the read credit C to the bet, a process branches as follows depending on whether the value of the credit C is equal to or more than the value of total bet in the previous game. When it is determined that the value of the credit C is less than the value of the total bet of the previous game (S16, NO), the routine ends without any operation of a process since a game cannot be started.

Meanwhile, when it is determined that the value of the credit C is equal to or more than the value of the total bet of the previous game (S16, YES), the value of the total bet of the previous game is subtracted from the value of the credit C. Then, the resulting value is stored in a predetermined memory area of the RAM 243. Afterwards, it is determined whether or not to start a mini game (S5).

When it is determined to start a mini game (S6, YES), a mini game start flag is activated (S7). Specifically, data showing that the game start flag activated is written into a storage area of a mini game start flag of the RAM 243. Meanwhile, when it is determined not to start a mini game (S6, NO), a combination determination process is carried out (S8).

In the combination determination process, a combination of symbols to be stopped on the payline L is determined first. Specifically, a command to generate a random number is sent to the random number generation circuit. Then, a random number within a predetermined range which is generated by the random number generation circuit, is sampled. The sampled random number is stored in a predetermined memory area of the RAM 243. Although a random number is generated in the random number generation circuit disposed outside the main CPU 241 in the present embodiment, a random number may be generated through a calculation by the main CPU 241, without the random number generating circuit.

Afterwards, a winning combination table for awarding a payout and a random number table stored in the ROM 242 are read. Those read winning combination table and random number table are stored in a predetermined memory area of the RAM 243. Still-displaying of symbols is controlled for each reel in accordance with the random number table.

Then, the random number table and the winning combination table stored in the predetermined memory area of the RAM 243 are read. Then, the random number written into the predetermined memory area of the RAM 243 is used as a parameter to refer to the random number table. A combination of symbols to be stopped on the payline L is then determined.

When a winning combination is determined, the winning combination table is stored into a predetermined memory area of the RAM 243. The random number and the winning combination table written in the predetermined memory area of the RAM 243 are read. In accordance with the random number and the winning combination table, a combination of symbols to be stopped and still-displayed are determined. During this process, the main CPU 241 reads out a symbol arrangement table stored from the ROM 242 and stores the table in a predetermined memory area of the RAM 243. The table is then used as a reference. The determined stop symbol data is stored in a predetermined memory area of the RAM 243. Alternatively, symbols to be stopped may be determined for each reel by using the random number table.

When a combination of symbols to be stopped on the payline L is determined, it is determined whether or not the combination is a winning combination. When the combination of symbols to be stopped on the payline L is a winning combination, a flag which indicates that a payout corresponding to the type of the winning combination will be awarded, is activated to generate the payout corresponding to the combination of symbols on the payline L forming the determined winning combination. The activated flag indicating that a payout will be awarded, is stored in a predetermined memory area of the RAM 243. To the contrary, when a combination of symbols to be stopped on the payline L is another combination, that is, a losing combination, the flag indicating that a payout will be awarded is not activated.

After the above combination determination process is carried out, reels 30A to 30E rotate so as to move symbols 301 in the display windows 7A to 7E (S9). Then, the rotation continues for a predetermined time (S10). Then, the rotation of reels 30A to 30E automatically stops (S11).

Then, it is determined whether or not a winning combination is formed through the combination determination process in S8 (S12). Specifically, this is done based on a status of the flag stored in the predetermined memory area of the RAM 243, which flag indicates a prize according to a combination of symbols on the payline L is awarded. When the flag is not activated (S12, NO), it is determined that a winning combination is not formed, and the routine ends.

Meanwhile, when the flag is activated (S12, YES), it is determined whether or not the winning combination formed in the combination determination process in S8 includes a “Blue 7.” Specifically, when the winning combination includes a “Blue 7” (S13, YES), the routine ends after the number of coins are paid out in accordance to the winning combination (S17).

Meanwhile, when the winning combination does not include a “BLUE 7” (S13, NO), it is determined whether or not a mini game end flag is activated (S14). Specifically, it is determined whether or not data showing that the mini game end flag is activated is written into a mini game end flag area of the RAM 243. S14 is repeated until the mini game end flag is activated (S14 NO). When the mini game end flag is activated (S14, YES), a free game process is carried out (S15). Then, the routine ends.

(Free Game Process)

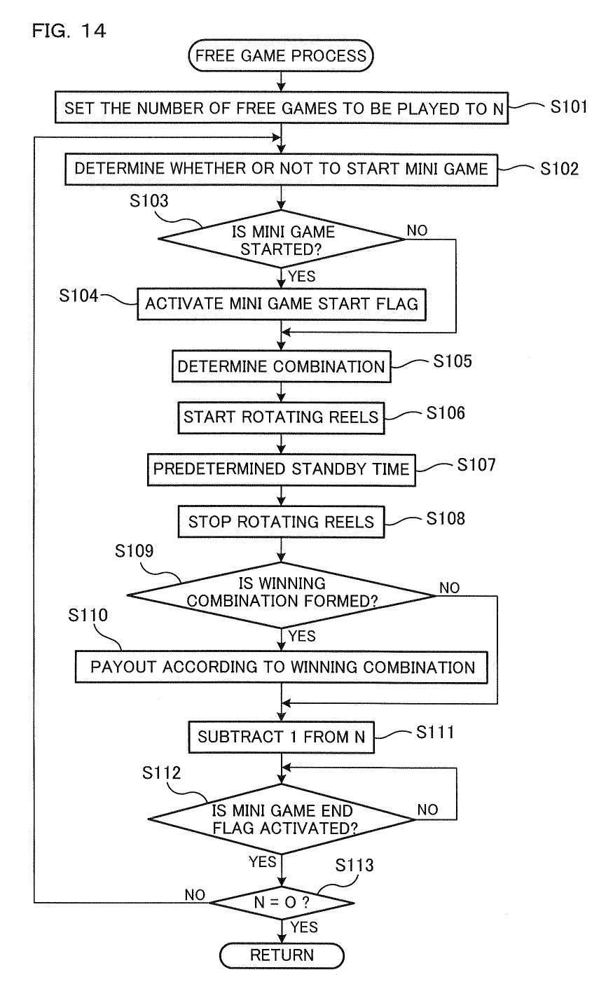

The following describes a free game process with reference to FIG. 14.

First, N denotes the number of free games (S101). The number of free games is determined according to accumulated points acquired in a mini game of a basic game.

Then, whether or not to start a mini game is determined (S102). When a mini game is determined to start (S103, YES), a mini game start flag is activated (S104). Specifically, data indicating that the mini game start flag is activated is written into a storage area of the RAM 243 for storing the mini game start flag. Afterwards, the process moves to S105.

Meanwhile, when a mini game is determined not to start (S103, NO), the process immediately moves to S105. Thus, a combination determination process same as above is carried out (S105). A difference in this combination determination process is that the referred random number table is a free game random number table (not shown). Then, reels 30A to 30E start to rotate (S106). After a predetermined standby time (S17), each reels 30A to 30E stops rotating (S108).

Then, whether or not a winning combination is formed is determined (S109). When a winning combination is not formed (S109, NO), the process moves to S111. Meanwhile, when a winning combination is formed (S109, YES), a game medium according to the winning combination is paid out (S110). Specifically, the number of coins to be paid out for the winning combination is calculated, referring to the payout control table of FIG. 7. A credit stored in a predetermined memory area of the RAM 243 is then read out. The payout value calculated above is added to the credit. The sum is stored in a predetermined memory area of the RAM 243, and the stored value is displayed on the credit display unit 9.

In S111, 1 is subtracted from N (S111). Then, whether or not a mini game end flag is activated is determined (S112). Specifically, it is determined whether or not data showing that the mini game end flag is activated is written into the mini game end flag area of the RAM 243. S112 is repeated when the mini game end flag is not activated (S112, NO).

When the mini game end flag is activated (S112, YES), whether N is 0 is determined (S113). When N is not 0 (S113, NO), the operation is carried out again from S102. On the other hand, when N is 0 (S113, YES), the routine ends.

(Mini Game Process)

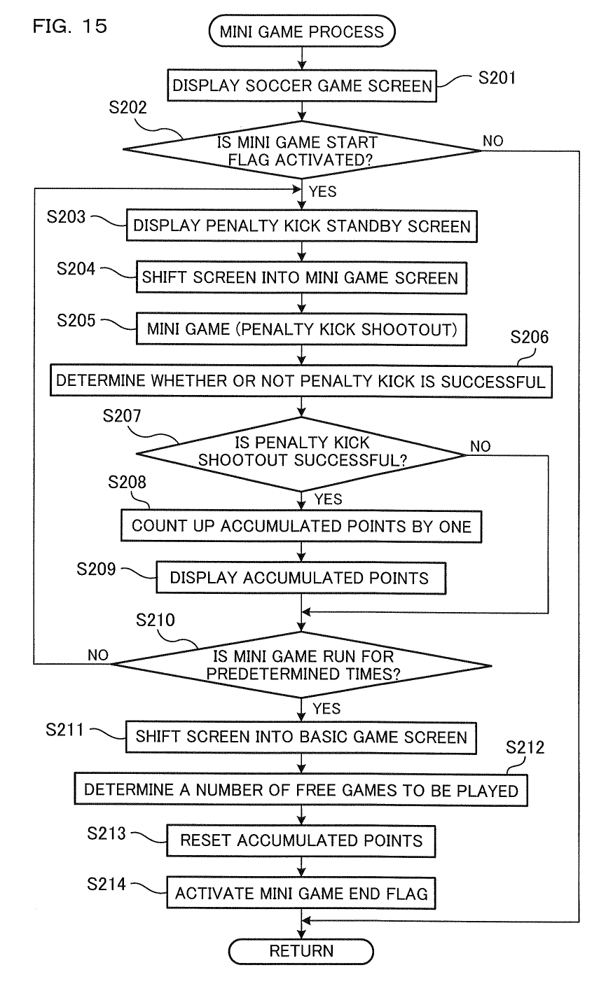

The following describes a mini game process with reference to FIG. 15.

First, a soccer game screen, which is an effect screen displayed when a mini game is not run, is displayed on the upper liquid crystal panel 5A (S201). Then, whether or not the mini game start flag is activated is determined. Specifically, it is determined whether data showing that the mini game start flag is activated is written into the game start flag area or the RAM 243 (S202).

When the mini game start flag is not activated (S202, NO), the routine ends. Meanwhile, when the mini game start flag is activated (S202, YES), screens on the upper liquid crystal panel 5A switches, as shown in FIG. 1, from a soccer game screen to a penalty kick standby screen which is an effect screen displayed during a mini game. Then, with a mini game screen 320 displayed on the central liquid crystal panel 5B, the display windows 7A to 7E and a mini game screen 320 are displayed one atop the other (S204).

Then, a penalty kick shootout as a mini game is started (S205). That is, an image of a goal keeper and a kicker facing each other is displayed, and a cheering sound of audience members is outputted. Then, when the kicker places a ball and intends to kick it, whether or not a penalty kick is successful, i.e., whether or not the mini game is successful, is determined (S206). Specifically, a random number is used to determine whether or not the mini game is successful.

Then, it is determined whether or not a penalty kick shootout (mini game) is successful (S207). When the penalty kick shootout is successful (S207, YES), the total number of accumulated points is counted up by 1 (S208), and the total number of accumulated points is displayed (S209). Then, it is determined whether or not the mini game is run a predetermined number of times (S210). Meanwhile, when the penalty kick shootout is unsuccessful (S207, NO), the total number of accumulated points is not counted up, and it is determined whether or not the mini game is played for predetermined number of times (S210).

When the mini game is not played for predetermined number of times (S210, NO), the process is carried out again from S203, and a next penalty shootout starts. When a penalty shootout is repeated for ten times or the like (S210, YES), the screen switches to a basic game screen (S211). After determining the number of times the free game is run (S212), the total number of accumulated points is reset. Then, after activating the mini game end flag (S214), this routine ends.

(Help Process)

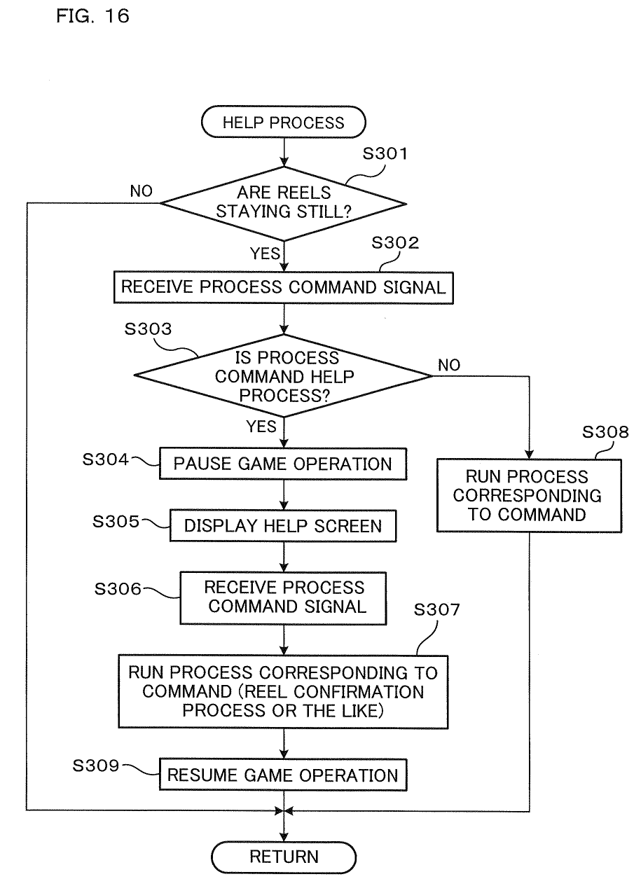

The slot machine 1 is capable of carrying out a help process shown in FIG. 16 aside from a basic game process and a free game process. Specifically, it is determined whether or not the reels 30A to 30E are staying still (S301). When the reels 30A to 30E are not staying still due to an operation of a basic game or the like (S301, NO), the routine ends. In short, a help screen is not displayed. Meanwhile, when the reels 30A to 30E are staying still (S301, YES), an input signal outputted when a player presses the touch panel 69 shown in FIG. 4, the outputted signal is received as a process command signal (S302). Then, it is determined whether or not the process command signal is related to a help process (S303). When it is not related to a help process (S303, NO), a process corresponding to the command is carried out (S308). Afterwards, this routine ends.

Meanwhile, when the command is related to a help process (S303, YES), after a game process such as a basic game or the like is paused (S304), the display changes into a help screen. In other words, the help button frame 310 is displayed on the central liquid crystal panel 5B, and various kinds of help item buttons including a reel confirmation button 304, a rule button 305 and a payout button 306 are displayed in the help button frame 310 (S305).

Then, reception of a next command signal is started (S306). For example, when a reel confirmation button 304 is pressed, an input signal is received as a process command signal starting a reel confirmation process (S307). After a game process is resumed (S309), this routine ends.

(Reel Confirmation Process)

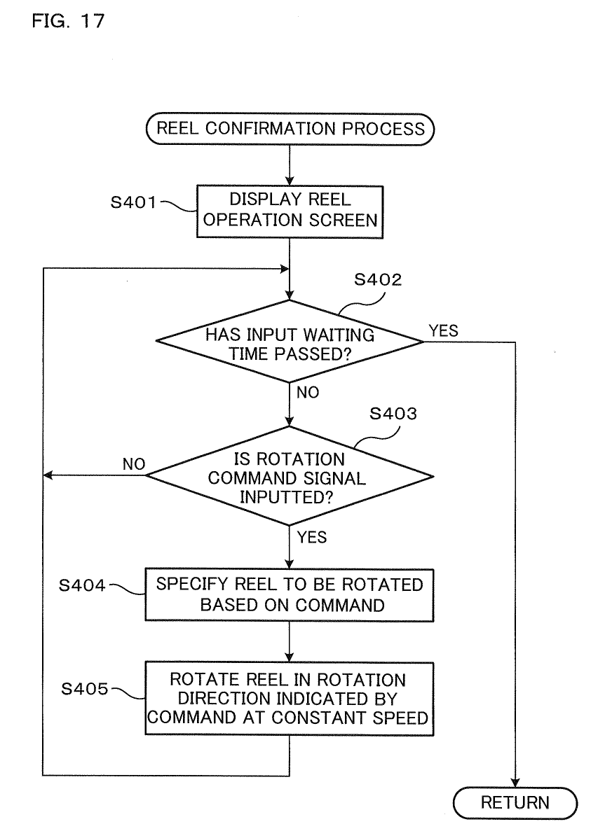

As shown in FIG. 17, when a reel confirmation process is carried out, a display switches to a reel operation screen shown in FIG. 10. In other words, direction symbols pointing upward or downward directions assigned to each of the reels 30A to 30E are displayed (S401).

Then, it is determined whether or not an input waiting time has passed (S402). When the input waiting time has passed (S402, YES), this routine ends. During the input waiting time (S402, NO), whether or not a rotation command signal is inputted is determined. Specifically, as shown in FIG. 10, an input signal outputted in response to a press operation of the touch panel 69, is received. Then, based on press position data and display position data of the direction symbol 302 in the input signal, it is determined whether or not the signal inputted is a rotation command signal (S403). When the signal inputted is not a rotation command signal (S403, NO), this routine ends. Meanwhile, when the signal inputted is a rotation command signal (S403, YES), one or more of the reels 30A to 30E positioned above the pressed position are specified as rotation target(s), based on a command included in the rotation command signal, i.e., pressed position data (S404). Then, the one or more of the specified reels 30A to 30E rotate at a constant speed in a direction indicated by the direction symbol 302 (S405). When the pressing is released, the operation of S405 ends and thus ending the routine.

Thus, a player is able to rotate the reels 30A to 30E in a direction indicated by the direction symbols 302 while s/he is pressing the direction symbols 302. Thus, a player is able to easily confirm, through the eyes, the symbols 301 on the reels 30A to 30E.

Although the reels 30A to 30E rotate at a constant speed when the direction symbols 302 are pressed in the present embodiment, the present invention however is not limited to this. In other words, the reels 30A to 30E may rotate at a speed corresponding to the pressed area of the direction symbols 302 when the direction symbols 302 are pressed. In this case, when a player presses the touch panel 69 with a strong pressing force, the reels 30A to 30E rotate at a high speed. On the other hand, when a player presses the touch panel 69 with a small pressing force, the reels 30A to 30E rotate at a constant speed. Thus, a player is capable of changing the rotation speed of the reels 30A to 30E.

The detailed description of the present invention provided hereinabove mainly focused on characteristics thereof for the purpose of easier understanding; however, the scope of the present invention shall be construed as broadly as possible, encompassing various forms of other possible embodiments, and therefore the present invention shall not be limited to the above description. Further, the terms and phraseology used in the present specification are adopted solely to provide specific illustration of the present invention, and in no case should the scope of the present invention be limited by such terms and phraseology. Further, it will be obvious for those skilled in the art that the other structures, systems, methods or the like are possible, within the spirit of the invention described in the present specification. The description of claims therefore shall encompass structures equivalent to the present invention, unless otherwise such structures are regarded as to depart from the spirit and scope of the present invention. Further, the abstract is provided to allow, through a simple investigation, quick analysis of the technical features and essences of the present invention by an intellectual property office, a general public institution, or one skilled in the art who is not fully familiarized with patent and legal or professional terminology. It is therefore not an intention of the abstract to limit the scope of the present invention which shall be construed on the basis of the description of the claims. To fully understand the object and effects of the present invention, it is strongly encouraged to sufficiently refer to disclosures of documents already made available.

The detailed description of the present invention provided hereinabove includes a process executed on a computer or computer network. The above descriptions and expressions are provided to allow the one skilled in the art to most efficiently understand the present invention. A process carried out in or by respective steps yielding one result or blocks with a predetermined processing function described in the present specification shall be understood as a process with no self-contradiction. Further, the electrical or magnetic signal is transmitted/received and written in the respective steps or blocks. It should be noted that such a signal is expressed in the form of bit, value, symbol, text, terms, number, or the like solely for the sake of convenience. Although the present specification occasionally personifies the processes carried out in the steps or blocks, these processes are essentially executed by various devices. Further, the other structures necessary for the steps or blocks are obvious from the above descriptions.

What is claimed is:

1. A gaming machine comprising:
a game requiring a player's bet;
a reel used in the game and mechanically driven to rotate;
a plurality of symbols on the reel;
an input device which receives an input by the player; and
a controller which is programmed to carry out the steps of:
(a1) receiving an input inputted through the input device; and
(a2) when the input is a rotation command related to the reel, rotating the reel while the rotation command is being inputted.

2. A gaming machine comprising:
a game requiring a player's bet;
a reel, for use in the game, which is mechanically driven to rotate and whose rotation direction is switchable;
a plurality of symbols on the reel;
a display capable of generating a video image;
an input device disposed so that at least a part of a display area of the display is visible through the input device, for receiving an input through a press operation by the player; and
a controller which is programmed to carry out the steps of:
(b1) displaying a video image of a direction symbol showing a rotation direction of the reel;
(b2) specifying an input position in the input device;
(b3) when the input position corresponds to a display position of the direction symbol, determining that a rotation command related to the reel is inputted; and
(b4) rotating the reel in a rotation direction indicated by the direction symbol while the rotation command is being inputted.

3. A gaming machine comprising:
a game requiring a player's bet;
a plurality of reels used in the game and mechanically driven to rotate;
a plurality of symbols on each of the reels;
a display capable of generating a video image;
an input device disposed so that at least a part of a display area of the display is visible through the input device, for receiving an input through a press operation by the player; and
a controller which is programmed to carry out the steps of:
(c1) associating each of the reels with a video image of a direction symbol indicating a rotation direction of the reel, and display the video images;
(c2) specifying an input position in the input device;
(c3) when the input position corresponds to display position of the direction symbol, determining that a rotation command related to a reel is inputted; and
(c4) rotating the reel associated with the direction symbol in a rotation direction indicated by the direction symbol while the rotation command is being inputted.

4. A gaming machine comprising:
a game requiring a player's bet;
a plurality of reels, for use in the game, which are mechanically driven to rotate and whose rotation directions are switchable;
a plurality of symbols on each of the reels;
a display capable of generating a video image;
an input device disposed so that at least a part of a display area is visible through the input device, for receiving an input through a press operation by the player; and
a controller which is programmed to carry out the steps of;
(d1) associating each of the reels with a video image of a direction symbol indicating a rotation direction of the reel, and display the video images;
(d2) specifying an input position in the input device;
(d3) when the input direction corresponds to a display position of the direction symbol, determining that a rotation command related to a reel is inputted; and
(d4) rotating the reel associated with the direction symbol in a rotation direction indicated by the direction symbol while the rotation command is being inputted.

5. A confirmation method of a plurality of symbols on a reel mechanically driven to rotate, and used in a game requiring a player's bet, comprising the steps of:
receiving an input by the player; and
when the input is a rotation command related to the reel, rotating the reel while the rotation command is being inputted.
